(19) United States
(12) Patent Application Publication
(10) Pub. No.: US 2005/0205581 A1
(43) Pub. Date: Sep. 22, 2005

(54) Underground tank shroud assembly

(75) Inventor: Greg E. McRae, Irving, TX (US)

Correspondence Address: BAKER BOTTS L.L.P., 2001 ROSS AVENUE, SUITE 600, DALLAS, TX, 75201-2980, US

(73) Assignee: TRN Business Trust

(21) Appl. No.: 10/807,217

(22) Filed: Mar. 22, 2004

(51) Int. Cl. F16L 5/00

(52) U.S. Cl. 220/567.1

(57) ABSTRACT

In accordance with a particular embodiment of the present invention, an underground tank shroud assembly includes a shroud comprising a top region and a base region. The shroud is configured to circumferentially enclose a riser of an underground tank. The assembly also includes a shroud lid configured to cover the top region of the shroud. The shroud lid is coupled to the shroud at a first hinge coupling and a second hinge coupling.

### TECHNICAL FIELD OF THE INVENTION

The present invention relates generally to underground tanks and, more particularly, to an underground tank shroud assembly.

### BACKGROUND OF THE INVENTION

Underground tanks are used to store various materials beneath the earth's surface. For example, underground tanks may be used to store liquid propane gas (LPG) for residential or commercial purposes. Underground tanks generally include a riser extending towards the surface that may be protected by a metallic shroud. The metallic shroud tends to corrode over time while underground. The shroud includes a small lid that opens to provide access to valves positioned at the top of the riser.

### SUMMARY OF THE INVENTION

The present invention provides an underground tank shroud assembly that substantially eliminates or reduces at least some of the disadvantages and problems associated with previous shroud assemblies.

In accordance with a particular embodiment of the present invention, an underground tank shroud assembly includes a shroud comprising a top region and a base region. The shroud is configured to circumferentially enclose a riser of an underground tank. The assembly also includes a shroud lid configured to cover the top region of the shroud. The shroud lid is coupled to the shroud at a first hinge coupling and a second hinge coupling.

The shroud lid may be operable to decouple from the shroud at either the first hinge coupling or the second hinge coupling to open the shroud lid. The shroud lid may be operable to pivot with respect to the shroud at the second hinge coupling when the shroud lid is opened if the shroud lid is decoupled from the shroud at the first hinge coupling to open the shroud lid, and the shroud lid may be operable to pivot with respect to the shroud at the first hinge coupling when the shroud lid is opened if the shroud lid is decoupled from the shroud at the second hinge coupling to open the shroud lid. Each hinge coupling may comprise a nut and bolt assembly to couple the shroud lid to the shroud.

The shroud may comprise plastic. The plastic may comprise polyurethane or polyethylene. The shroud may comprise a generally conical shape. A bottom edge of the base region may be configured to conform to a convex top surface of the underground tank. The underground tank may be configured to store liquid propane gas (LPG). The shroud may comprise at least one bracket slot proximate the base region. The at least one bracket slot may be configured to receive a respective bracket of the underground tank to hold the shroud into place when installed.

In accordance with another embodiment, an underground tank and shroud assembly comprises an underground tank. The underground tank comprises a tank body and a riser extending substantially vertically from the body towards a surface of the earth. The tank and shroud assembly also comprises a shroud assembly comprising a shroud comprising a top region and a base region. The shroud is configured to circumferentially enclose the riser of the underground tank. The shroud assembly also comprises a shroud lid configured to cover the top region of the shroud. The shroud lid is coupled to the shroud at a first hinge coupling and a second hinge coupling.

Technical advantages of particular embodiments of the present invention include a shroud assembly comprising a lid and a shroud for circumferentially enclosing a riser of an underground tank. The shroud and lid are made of a plastic material which decreases the possibility of corrosion beneath the earth's surface. Accordingly, the shroud and lid may be used for longer periods of time. The lid may be coupled to the shroud using multiple hinge couplings to provide more than one location from which the lid may be opened. Accordingly, a user may choose the more accessible hinge coupling as the coupling at which the user will open the lid.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of particular embodiments of the invention and their advantages, reference is now made to the following descriptions, taken in conjunction with the accompanying drawings, in which:

FIG. 1 illustrates a shroud assembly and an underground tank, in accordance with a particular embodiment of the present invention;

FIG. 2 illustrates the shroud assembly of FIG. 1 with the lid in an open position, in accordance with a particular embodiment of the present invention;

FIG. 3 is an exploded view illustrating one hinge coupling of the shroud assembly of FIG. 1, in accordance with a particular embodiment of the present invention;

FIG. 4 is a cross-sectional view of the shroud assembly of FIG. 1 taken along line 4-4 of FIG. 1, in accordance with a particular embodiment;

FIG. 5 illustrates a shroud assembly and an underground tank, in accordance with another embodiment of the present invention;

FIG. 6 illustrates the underside of the lid of the shroud assembly of FIG. 5, in accordance with a particular embodiment of the present invention;

FIG. 7A is an exploded view illustrating the lid and shroud of FIG. 5, in accordance with a particular embodiment of the present invention; and

FIG. 7B is an exploded view further illustrating a lug slot of the shroud lid of FIG. 7A, in accordance with a particular embodiment of the present invention.

### DETAILED DESCRIPTION OF THE INVENTION

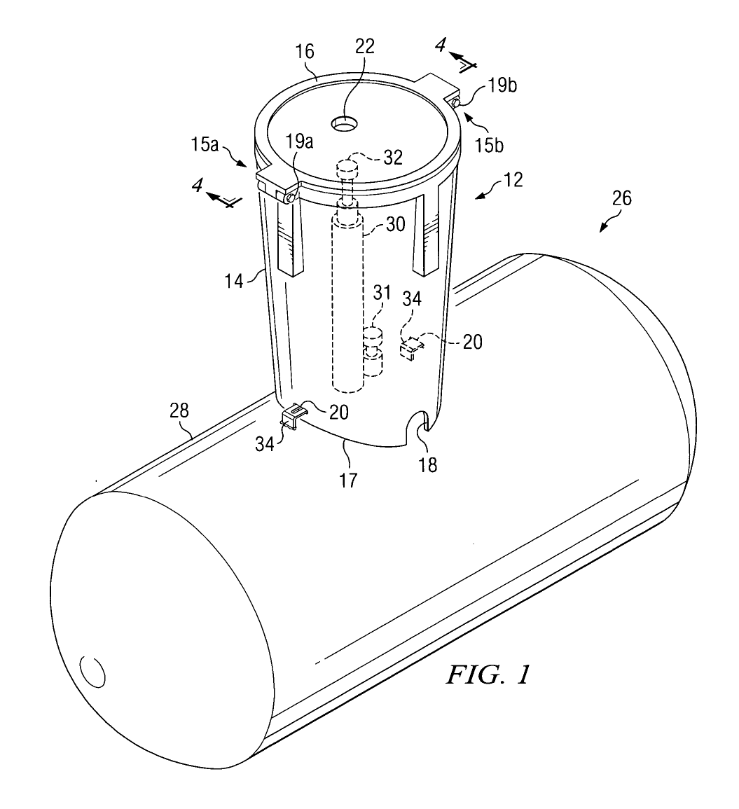

FIG. 1 illustrates a shroud assembly 12 for use with an underground tank 26, in accordance with a particular embodiment of the present invention. When underground tank 26 is positioned beneath the earth's surface, shroud assembly 12 is positioned to circumferentially enclose a riser 30 of underground tank 26. Shroud assembly 12 comprises a shroud 14 and a lid 16. In particular embodiments, shroud 14 and lid 16 may comprise a plastic material, such as polyurethane or polyethylene, and shroud 14 may be manufactured using a rotary mold method. In some embodiments, shroud 14 and lid 16 may substantially or completely comprise a plastic material. In particular embodiments, shroud 14 and lid 16 may not comprise any metallic material. Manufacturing shroud assembly 12 with a plastic material decreases the possibility of corrosion when the shroud assembly has been underground for a substantial period of time. Accordingly, the shroud assembly may have a longer useful life. In the illustrated embodiment, the side of shroud 14 is tapered such that the shroud comprises a generally conical shape. Such tapering facilitates stacking of multiple shrouds which reduces shipping and handling labor and expenses. Shrouds in accordance with other embodiments may, however, comprise other shapes or configurations.

Underground tank 26 may store liquid propane gas (LPG) or other composition below the earth's surface. The storage capacity of tank 26 may vary in different embodiments. In a particular embodiment, underground tank 26 may have a storage capacity of 120 to 2000 water gallons (wg). Underground tank 26 comprises a body 28 for such storage and a riser 30 extending generally vertical towards the earth's surface when the tank is installed underground. The use of riser 30 enables tank 26 to be accessed from the earth's surface while body 28 is positioned below a freeze depth below the earth's surface. In particular embodiments, riser 30 may have a length ranging from fourteen to twenty-eight inches. Body 28 and riser 30 of underground tank 26 comprise carbon steel; however in other embodiments components of underground tanks may comprise other compositions. Underground tank 26 includes a withdrawal valve 31 for withdrawal of the stored composition, such as LPG. The top of riser 30 may include a plurality of valves, such as a relief valve 32. Particular embodiments include a service valve at the top of riser 30 serving several purposes, including a service opening to which a gas line may be connected.

A bottom edge 17 of shroud 14 is shaped to conform to a convex surface of body 28 of tank 26. Shroud 14 includes a cutout portion 18 at its base to provide a recess through which a gas line may pass for connection with withdrawal valve 31 of tank 26. Shroud 14 also includes slots 20 through which brackets 34 of underground tank 26 may slide during installation of shroud 14. The positioning of brackets 34 within slots 20 prevents rotation or other movement of the shroud while underground. In the illustrated embodiment, brackets 34 are L-shaped brackets. In particular embodiments, brackets 34 may have different widths from each other to slide in slots 20 having different widths so that shroud assembly 12 will only be able to be positioned upon the tank in one manner. This ensures that opening 22 is positioned above valve 32 when the shroud assembly is in place. Other embodiments may include other components to hold shroud 14 in place around riser 30 of tank 26. Soil packed around shroud 14 may also aid in holding shroud 14 in place when installed underground.

Lid 16 of shroud assembly 12 comprises a general circular shape in the illustrated embodiment. Lid 16 is coupled to shroud 14 using hinge couplings 15a and 15b. Each hinge coupling 15a and 15b allows lid 16 to pivot with respect to shroud 14 to open the lid. In this embodiment, hinge couplings 15a and 15b each include a bolt assembly with a bolt 19 (hinge coupling 15a includes bolt 19a and hinge coupling 15b includes bolt 19b). Each bolt 19 passes through recesses formed in lid 16 and shroud 14 to secure the lid to the shroud and to provide the ability of the lid to pivot with respect to the shroud. However, couplings in other embodiments may include any suitable fasteners or other components to aid in coupling a shroud assembly lid to the shroud. Such components may include, for example, screws or any other suitable fastening component. Moreover, hinge couplings in other embodiments may not include one or more of the illustrated components of hinge couplings 15. While the illustrated embodiment includes two hinge couplings approximately 180 degrees apart at a generally circular lid, other embodiments may include any number of couplings at any suitable position to secure a shroud assembly lid to the shroud.

The use of more than one hinge coupling in particular embodiments allows a user to open lid 16 from either coupling. For example, if a user desired to open lid 16 to access components of tank 26, the user may remove bolt 19a from hinge coupling 15a or bolt 19b from hinge coupling 15b. If the user removed bolt 19a from hinge coupling 15a, the user may then lift lid 16 proximate to hinge coupling 15a such that the lid pivots at hinge coupling 15b which keeps the lid fastened to the shroud. Similarly, if the user removed bolt 19b from hinge coupling 15b, the user may then lift lid 16 proximate to hinge coupling 15b such that the lid pivots at hinge coupling 15a which keeps the lid fastened to the shroud. A user may choose to open the lid at a particular hinge coupling based on any of a number of factors. For example, in one situation one coupling may be more accessible than the other.

Lid 16 includes a relief valve hole 22 which aligns with a relief valve 32 of riser 30 when lid 16 is positioned upon shroud 14. In particular embodiments, lid 16 may comprise a diameter ranging from approximately sixteen to twenty-one inches, such as 19⅛ inches.

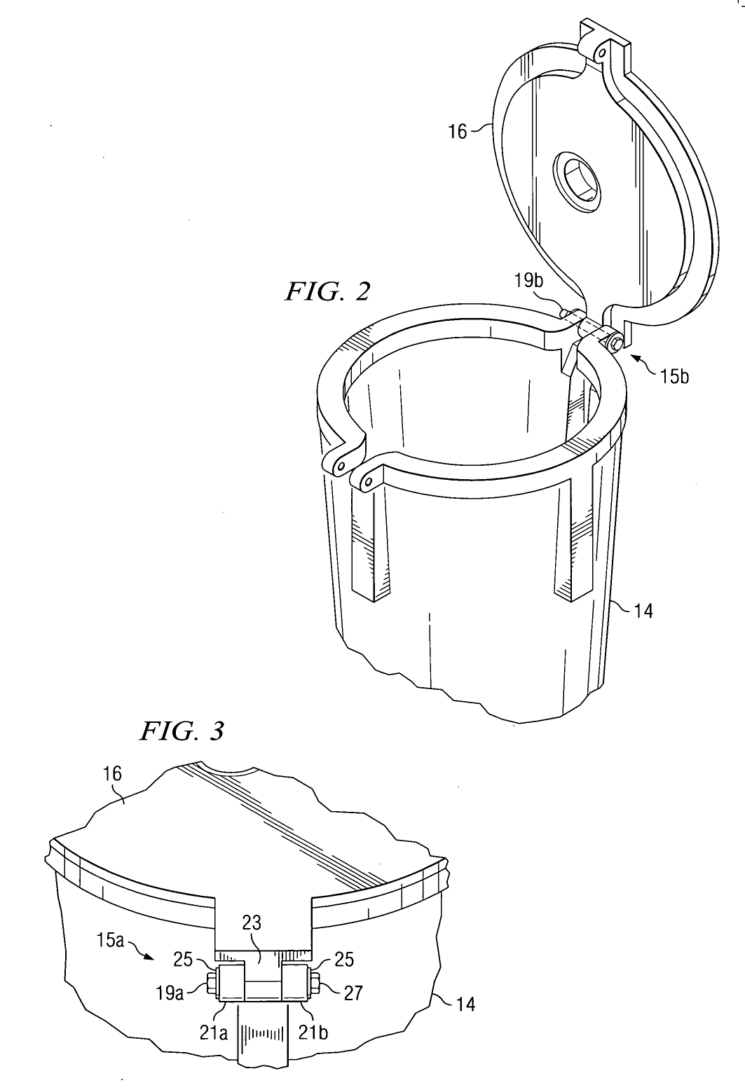

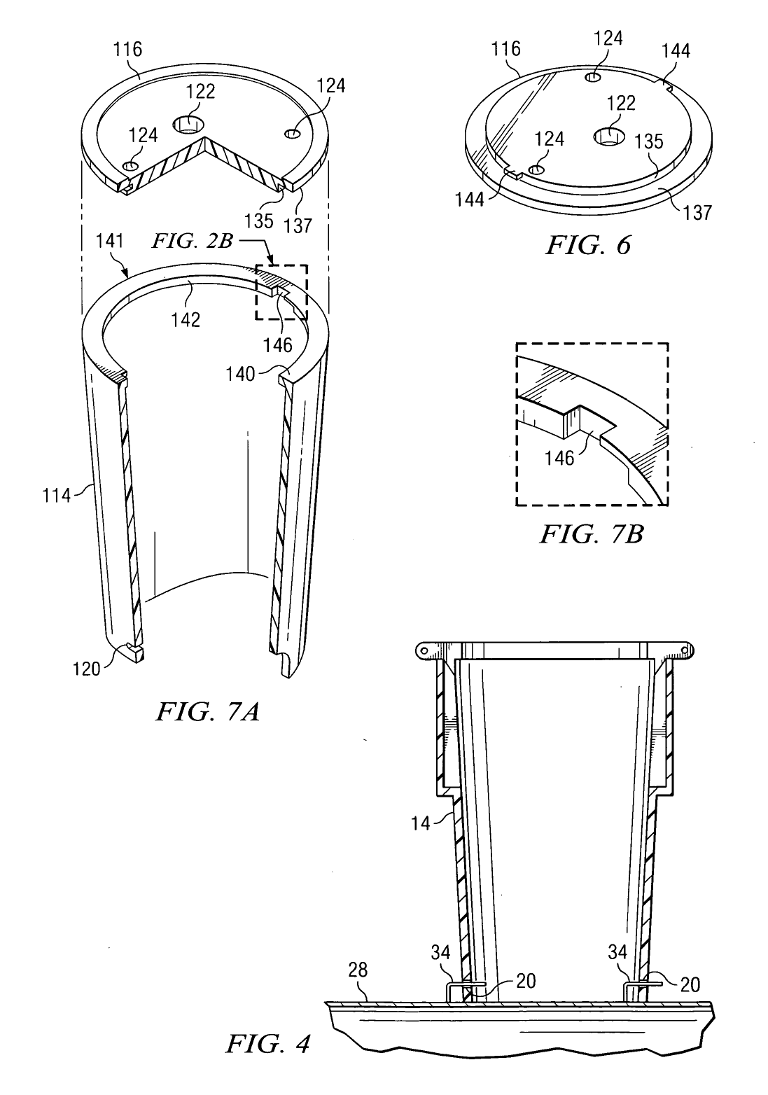

FIG. 2 illustrates the shroud assembly of FIG. 1 with lid 16 in an open position, in accordance with a particular embodiment of the present invention. As illustrated, lid 16 is in an open position with hinge coupling 15b still secured to provide pivoting movement of the lid with respect to shroud 14. Thus, a user may have removed bolt 19a of hinge coupling 15a in order to open the lid. In the illustrated embodiment, lid 16 is open in an approximately 90 degree-position with respect to shroud 14. Hinge couplings in particular embodiments may include stops, other components or suitable shapes or configurations to restrict the movement of lid 16 with respect to shroud 14 when lid 16 is opened by a user. For example, in some embodiments such movement may be restricted to an amount less than or greater than 90 degrees.

FIG. 3 is an exploded view illustrating hinge coupling 15a of the shroud assembly of FIG. 1, in accordance with a particular embodiment of the present invention. Hinge coupling 15a includes bolt 19a, nut 27 and washers 25. In the illustrated embodiment, shroud 14 includes protrusions 21a and 21b, each with a recess through which bolt 19a passes. Lid 16 includes a protrusion 23 positioned between protrusions 21a and 21b of shroud 14 when the lid is secured to shroud 14. Bolt 19a also passes through a recess of protrusion 23 when the lid is secured to the shroud. When lid 16 is opened, protrusion 23 of lid 16 rotates with respect to protrusions 21a and 21b. In some cases, lid 16 may rotate with respect to bolt 19a, while in other cases the bolt may rotate with lid 16 such that the bolt rotates within the recesses of protrusions 21a and 21b.

In particular embodiments, hinge couplings 15a and 15b may have different configurations such that lid 16 will fit on shroud 14 in only one way. For example, one hinge coupling may have a protrusion 23 with a different width than the protrusion 23 of the other hinge coupling. In this example, each hinge coupling's protrusions 21a and 21b will be appropriately spaced apart to correspond to the width of their respective protrusion 23. Allowing the lid to fit on the shroud in only one way ensures that opening 22 is positioned above valve 32 when the lid is in place.

As indicated above, it should be understood that other embodiments may include other types of couplings utilizing any other suitable components or shapes or configurations to secure a shroud assembly lid to the shroud.

FIG. 4 is a cross-sectional view of shroud 14 taken along line 4-4 of FIG. 1. As illustrated, shroud 14 has a general conical shape. As discussed above, brackets 34 coupled to body 28 of the underground tank slide into slots 20 of shroud 14 to aid in preventing rotation of the shroud while underground.

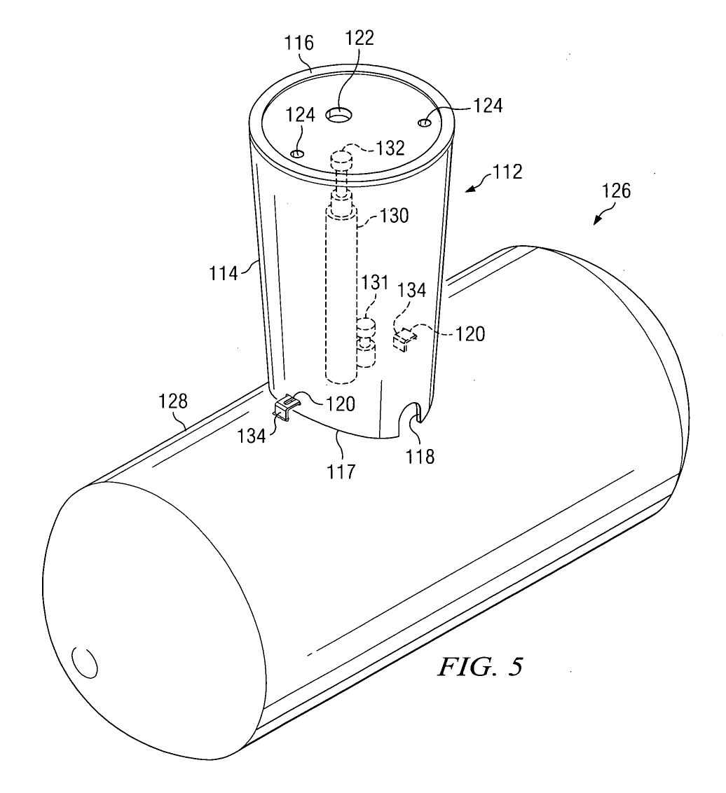

FIG. 5 illustrates a shroud assembly 112 for use with an underground tank 126, in accordance with another embodiment of the present invention. When underground tank 126 is positioned beneath the earth's surface, shroud assembly 112 is positioned to circumferentially enclose a riser 130 of underground tank 126. Shroud assembly 112 comprises a shroud 114 and a lid 116. In particular embodiments, shroud 114 and lid 116 may comprise a plastic material, such as polyurethane or polyethylene, and shroud 114 may be manufactured using a rotary mold method. In some embodiments, shroud 114 and lid 116 may substantially or completely comprise a plastic material. In particular embodiments, shroud 114 and lid 116 may not comprise any metallic material. In the illustrated embodiment, the side of shroud 114 is tapered such that the shroud comprises a generally conical shape. Shrouds in accordance with other embodiments may however comprise other shapes or configurations.

Underground tank 126 comprises a body 128 for storage and a riser 130 extending generally vertical towards the earth's surface when the tank is installed underground. In particular embodiments, riser 130 may have a length ranging from fourteen to twenty-eight inches. Body 128 and riser 130 of underground tank 126 comprise carbon steel; however in other embodiments components of underground tanks may comprise other compositions. Underground tank 126 includes a withdrawal valve 131 for withdrawal of the stored composition, such as LPG. The top of riser 130 may include a plurality of valves, such as a relief valve 132. Particular embodiments include a service valve at the top of riser 130 serving several purposes, including a service opening to which a gas line may be connected.

A bottom edge 117 of shroud 114 is shaped to conform to a convex surface of body 128 of tank 126. Shroud 114 includes a cutout portion 118 at its base to provide a recess through which a gas line may pass for connection with withdrawal valve 131 of tank 126. Shroud 114 also includes slots 120 through which brackets 134 of underground tank 126 may slide during installation of shroud 114. The positioning of brackets 134 within slots 120 prevents rotation or other movement of the shroud while underground. Other embodiments may include other components to hold shroud 114 in place around riser 130 of tank 126.

Lid 116 of shroud assembly 112 comprises a general circular shape in the illustrated embodiment. Lid 116 may be rotated when placed upon shroud 114 in order to lock lid 116 into place, as further discussed below. Lid 116 includes a relief valve hole 122 which aligns with a relief valve 132 of riser 130 when lid 116 is positioned upon shroud 114. Lid 116 also includes two twist holes 124 through which a user may insert tools or his fingers in order to twist and remove lid 116 off of shroud 114. Other embodiments may include another number of twist holes or may utilize another mechanism to aid in placement and removal of lid 16 with respect to shroud 114.

FIG. 6 illustrates the underside of lid 116 of shroud assembly 112 of FIG. 5, in accordance with a particular embodiment. The underside of lid 116 includes an extended portion 135 and an overhang portion 137. Lid 116 includes lugs 144 protruding from extended portion 135. Lugs 144 aid in locking lid 116 into place upon the shroud as further discussed below.

FIG. 7A is an exploded view illustrating lid 116 and shroud 114 of FIG. 5, in accordance with a particular embodiment of the present invention. When lid 116 is twisted into position upon shroud 114, a bottom surface of overhang portion 137 rests upon a top rim surface 140 of a rim portion 141 of shroud 114. In such position, an inside rim surface 142 of shroud 114 surrounds extended portion 135 of lid 116.

Rim portion 141 of shroud 114 includes lug slots 146 through which lugs 144 may be vertically inserted when lid 116 is placed upon shroud 114. Lid 116 may then be rotated (e.g., in a clockwise direction in the illustrated embodiment) so that lugs 144 of lid 116 slide within lug slots 146 such that rim portion 141 of shroud 114 prevents vertical removal of lid 116. Lid 116 must be rotated in an opposite direction (e.g., in a counter-clockwise direction in the illustrated embodiment) before lugs 144 may vertically slide out of lug slots 146 in order to remove lid 116 from shroud 114. While lugs 144 and a top portion of lug slots 146 have a general rectangular configuration in this embodiment, it should be understood that other embodiments may include lugs and/or lug slots having other shapes or configurations. Moreover, shroud assemblies in accordance with other embodiments may include other mechanisms for locking the lid into place on the shroud.

FIG. 7B is an exploded view further illustrating a lug slot 146 of the shroud lid of FIG. 7A, in accordance with a particular embodiment. As discussed above, shroud lids of other embodiments may include lug slots having other shapes or configurations.

Although the present invention has been described in detail with reference to particular embodiments, it should be understood that various other changes, substitutions, and alterations may be made hereto without departing from the spirit and scope of the present invention. The present invention contemplates great flexibility in the configuration of a shroud assembly for use with an underground tank.

Numerous changes, substitutions, variations, alterations and modifications may be ascertained by those skilled in the art and it is intended that the present invention encompass all such changes, substitutions, variations, alterations and modifications as falling within the spirit and scope of the appended claims. Moreover, the present invention is not intended to be limited in any way by any statement in the specification that is not otherwise reflected in the claims.

1. An underground tank shroud assembly, comprising:
a shroud comprising a top region and a base region, the shroud configured to circumferentially enclose a riser of an underground tank; and
a shroud lid configured to cover the top region of the shroud, the shroud lid coupled to the shroud at a first hinge coupling and a second hinge coupling.

2. The assembly of claim 1, wherein the shroud lid is operable to decouple from the shroud at either the first hinge coupling or the second hinge coupling to open the shroud lid.

3. The assembly of claim 2, wherein:
the shroud lid is operable to pivot with respect to the shroud at the second hinge coupling when the shroud lid is opened if the shroud lid is decoupled from the shroud at the first hinge coupling to open the shroud lid; and
the shroud lid is operable to pivot with respect to the shroud at the first hinge coupling when the shroud lid is opened if the shroud lid is decoupled from the shroud at the second hinge coupling to open the shroud lid.

4. The assembly of claim 1, wherein each hinge coupling comprises a nut and bolt assembly to couple the shroud lid to the shroud.

5. The assembly of claim 1, wherein the shroud comprises plastic.

6. The assembly of claim 5, wherein the plastic comprises polyurethane.

7. The assembly of claim 5, wherein the plastic comprises polyethylene.

8. The assembly of claim 1, wherein the shroud comprises a generally conical shape.

9. The assembly of claim 1, wherein a bottom edge of the base region is configured to conform to a convex top surface of the underground tank.

10. The assembly of claim 1, wherein the underground tank is configured to store liquid propane gas (LPG).

11. The assembly of claim 1, wherein the shroud comprises at least one bracket slot proximate the base region, the at least one bracket slot configured to receive a respective bracket of the underground tank to hold the shroud into place when installed.

12. The assembly of claim 1, wherein the shroud lid comprises a diameter of sixteen to twenty-one inches.

13. An underground tank shroud assembly, comprising:
a shroud comprising a top region and a base region, the shroud configured to circumferentially enclose a riser of an underground tank; and
a shroud lid configured to cover the top region of the shroud, wherein the shroud comprises plastic.

14. The assembly of claim 13, wherein the shroud lid is coupled to the shroud at a first hinge coupling and a second hinge coupling.

15. The assembly of claim 14, wherein:
the shroud lid is operable to pivot with respect to the shroud at the second hinge coupling when the shroud lid is opened if the shroud lid is decoupled from the shroud at the first hinge coupling to open the shroud lid; and
the shroud lid is operable to pivot with respect to the shroud at the first hinge coupling when the shroud lid is opened if the shroud lid is decoupled from the shroud at the second hinge coupling to open the shroud lid.

16. The assembly of claim 14, wherein each hinge coupling comprises a nut and bolt assembly to couple the shroud lid to the shroud.

17. The assembly of claim 13, wherein the plastic comprises polyurethane.

18. The assembly of claim 13, wherein the plastic comprises polyethylene.

19. The assembly of claim 13, wherein the shroud comprises a generally conical shape.

20. The assembly of claim 13, wherein a bottom edge of the base region is configured to conform to a convex top surface of the underground tank.

21. The assembly of claim 13, wherein the underground tank is configured to store liquid propane gas (LPG).

22. The assembly of claim 13, wherein the shroud comprises at least one bracket slot proximate the base region, the at least one bracket slot configured to receive a respective bracket of the underground tank to hold the shroud into place when installed.

23. The assembly of claim 13, wherein the shroud lid comprises a diameter of sixteen to twenty-one inches.

24. An underground tank and shroud assembly, comprising:
an underground tank comprising:
a tank body; and
a riser extending substantially vertically from the body towards a surface of the earth; and
a shroud assembly comprising:
a shroud comprising a top region and a base region, the shroud configured to circumferentially enclose the riser of the underground tank; and
a shroud lid configured to cover the top region of the shroud, the shroud lid coupled to the shroud at a first hinge coupling and a second hinge coupling.

25. The assembly of claim 24, wherein the shroud lid is operable to decouple from the shroud at either the first hinge coupling or the second hinge coupling to open the shroud lid.

26. The assembly of claim 25, wherein:
the shroud lid is operable to pivot with respect to the shroud at the second hinge coupling when the shroud lid is opened if the shroud lid is decoupled from the shroud at the first hinge coupling to open the shroud lid; and
the shroud lid is operable to pivot with respect to the shroud at the first hinge coupling when the shroud lid is opened if the shroud lid is decoupled from the shroud at the second hinge coupling to open the shroud lid.

27. The assembly of claim 24, wherein each hinge coupling comprises a nut and bolt assembly to couple the shroud lid to the shroud.

28. The assembly of claim 24, wherein the shroud comprises plastic.

29. The assembly of claim 28, wherein the plastic comprises polyurethane.

30. The assembly of claim 28, wherein the plastic comprises polyethylene.

31. The assembly of claim 24, wherein the shroud comprises a generally conical shape.

32. The assembly of claim 24, wherein a bottom edge of the base region is configured to conform to a convex top surface of the underground tank.

33. The assembly of claim 24, wherein the underground tank is configured to store liquid propane gas (LPG).

34. The assembly of claim 24, wherein:
the shroud comprises at least one bracket slot proximate the base region; and
the underground tank comprises at least one bracket, each bracket configured to slide into a respective bracket slot of the shroud to hold the shroud into place when installed.

35. The assembly of claim 24, wherein the shroud lid comprises a hole approximately vertically aligned with the riser of the underground tank.

36. The assembly of claim 24, wherein the shroud lid comprises a diameter of sixteen to twenty-one inches.

37. An underground tank shroud assembly, comprising:
a shroud comprising a top region and a base region, the shroud configured to circumferentially enclose a riser of an underground tank; and
a shroud lid configured to cover the top region of the shroud, the shroud lid configured to lock into place upon rotation of the shroud lid.

38. The assembly of claim 37, wherein the shroud lid comprises at least one lug configured to slide in a respective lug slot of the top region of the shroud to lock the shroud lid into place.

39. The assembly of claim 38, wherein each lug slot is configured to:
receive its respective lug vertically; and
allow general horizontal rotation of its respective lug in a first direction in order to lock the shroud lid into place such that the shroud lid must be rotated in a second direction opposite from the first direction in order to remove the shroud lid from the shroud.

40. The assembly of claim 37, wherein the shroud comprises plastic.

41. The assembly of claim 37, wherein the shroud comprises a generally conical shape.

42. The assembly of claim 37, wherein a bottom edge of the base region is configured to conform to a convex top surface of the underground tank.

43. The assembly of claim 37, wherein the shroud lid comprises at least one twist hole through which a device may be inserted to rotate the shroud lid.

44. The assembly of claim 37, wherein the shroud comprises at least one bracket slot proximate the base region, the at least one bracket slot configured to receive a respective bracket of the underground tank to hold the shroud into place when installed.
